(19) United States
(12) Patent Application Publication
(10) Pub. No.: US 2012/0254332 A1
(43) Pub. Date: Oct. 4, 2012

(54) SYSTEMS AND METHODS FOR IMPORTING MEDIA FILE EMAIL ATTACHMENTS

(76) Inventor: William Irvin, San Francisco, CA (US)

(21) Appl. No.: 13/436,379

(22) Filed: Mar. 30, 2012

Related U.S. Application Data
(60) Provisional application No. 61/470,430, filed on Mar. 31, 2011.

(51) Int. Cl. G06F 15/16

(52) U.S. Cl. 709/206

(57) ABSTRACT

The invention provides systems and methods for importing media files from emails. A method for importing media files includes searching email accounts for media files attached to or embedded in emails, and importing any media files found in the search from the emails accounts into an electronic storage unit. The media files in some cases can be processed, such as by converting the media files from one format to another. A harvested media file ready for use can be committed for use with broadcast content.

### CROSS-REFERENCE

This application claims priority to U.S. Provisional Patent Application Ser. No. 61/470,430, filed Mar. 31, 2011, which is entirely incorporated herein by reference.

### BACKGROUND OF THE INVENTION

Broadcasters routinely create programming content, such as commercials, with the aid of media files (e.g., image, audio and/or video files) directed to the broadcasters via electronic mail (email) as attachments. Email is typically exchanged with the aid of hardware and software that help a sender prepare an email message and transmit the email message to a recipient using a computer network, such the Internet and/or an intranet. A sender attaches a file to an email. Once a file is attached to the email, the email is transmitted over a communications network (e.g., the Internet) to a recipient computer system. Software can be used to view the file once received as an email attachment.

Ordinarily, a file received as an email attachment by a user is manually detached from the email and copied to an electronic storage location on a computer system of the recipient. In cases in which numerous emails arrive on the computer system, detaching attachments from the emails and copying the files to the computer system can be burdensome. In addition, if the user wishes to organize the attachments, the user typically has to manually create folders and subfolders, which places additional burden on the user.

In the case of a media files (e.g., audio files, video files) received for purposes of creating commercial spots, a recipient user may have to sort through a tremendous number of emails and attachments and manually detach the attachments from emails and store the files on a data repository, such as a hard disk of the user. The files can be stored in folders and subfolders that enable the user to catalogue the files, but in cases in which the volume of emails and attachments with media files is high, sorting through all of the emails and copying attached files to the data repository can take considerable time and effort.

### SUMMARY OF THE INVENTION

Recognized herein is the need for automating the process for saving media files detached from emails to locations related to the saving locations of the corresponding emails, as well associating such media files for use with broadcast content.

The invention provides systems and methods for searching for media files (e.g., audio files) embedded in or attached to electronic mail (“email”) messages and subsequently storing the audio files in a database or repository. The system can associate metadata (i.e., data about data) with each audio file stored in the database or repository. The metadata and stored audio file can be associated with a media asset.

In some embodiments, systems are provided for automatically retrieving media files from email messages and storing the media files in an electronic storage location (or unit), such as a database. The media files can be subsequently used by a broadcaster to prepare broadcast content, such as commercials. In some embodiments, media content from emails is stored in a data repository, indexed and subsequently made available for use in preparing commercials.

Systems provided herein can advantageously save a user time and effort that would otherwise be lost in manually retrieving and storing media files from email messages. Systems of the invention can be fully integrated and automated systems, enabling users to retrieve media content from emails and use the media content to prepare broadcast content, such as commercials.

In some embodiments, a media file management system (“system”) searches for media files (e.g., audio files) that are attached to, or embedded in, an email, and automatically imports the media files, into an electronic storage location. In some example, audio files (or “spots”) are imported into the electronic storage location of the system. The system can modify the media files for importation into the storage location. In an example, the system modifies an audio file for importation. The system can make the media file available for subsequent use and/or processing by a user.

In some embodiments, a system can automatically detect and import spots. This can enable the system to streamline the process by which a user searches for, finds, imports and dubs spots. In some implementations, when an advertiser or an agency forwards or transmits (such as, e.g., by email) a spot to a user, the system automatically detects the spot and imports the spot into a storage location or file repository of the system, such as a storage location or file repository of the system of associated with the system, such as a storage location located in a remote server (i.e., the “cloud”). The spot may appear in a list widget in a production room or homepage of the user and associated with the system. From a list provided in the list widget the user can select a spot that the user desires to dub and enter header information for the spot.

In some embodiments, systems and methods are provided that enable users to dub commercials, advertisements and/or programs and insert or modify such media with at least a portion of an audio file retrieved form an email. In some cases, a system can facilitate the searching for and importing audio files, making them readily available for use. In some embodiments, a user interface enables a user to view media assets and retrieve metadata information or listen to an audio file associated with media assets. The system may enable a user to view an email message in which the audio file was provided as an attachment or embedded object.

An aspect of the invention provides a method for retrieving a media file from an electronic mail for use with broadcast content, comprising (a) searching, with the aid of a processor, an electronic mail (email) account for an email having a media file embedded in or provided as an attachment to the email; (b) identifying from the search an email having a media file embedded in or provided as an attachment to the email; (c) importing the media file from the email into an electronic storage unit; and (d) processing, with the aid of a processor, the media file for use in the broadcast content.

Another aspect of the invention provides a method for retrieving media files from electronic mail (email) for use with broadcast content, comprising (a) performing, with the aid of a processor, a search of one or more email accounts for email having media files for use with the broadcast content; (b) importing from the one or more email accounts a media file, wherein the media file is attached to or embedded in an email revealed in the search, and wherein the media file is imported into a dedicated electronic storage unit on a server; (c) forming, with the aid of a processor, a media asset from the media file, the media asset ready for use with broadcast content, wherein the media asset includes metadata associated with the media file; and (d) generating, with the aid of a processor, a list of media assets for display to a user with the aid of a graphical user interface on a system communicatively coupled to the server, the list of media assets having the media asset.

Another aspect of the invention provides a method for automatically ingesting media file attachments for use with broadcast content, comprising (a) scanning email in one or more email accounts for media file attachments corresponding to the broadcast content; (b) importing media file attachments from the one or more email accounts into a data repository on a server; (c) generating a list of media assets for display on a graphical user interface (GUI), each media asset on the list associated with a media file among the media file attachments; and (d) committing a media asset from the list for use with the broadcast content.

Another aspect of the invention provides a method of ingesting media file attachments for commercial spot(s) automatically from electronic mail (email), comprising the steps of (a) scanning email from one or more email accounts for media file attachments corresponding to commercial spot(s); (b)importing the media file attachments for commercial spot(s) from the one or more email accounts into an electronic storage location located on a server; (c) providing a graphical user interface displaying a list having the media file attachments imported from the one or more emails accounts; and (d) committing a selected media file from the list for use with a selected commercial spot.

Another aspect of the invention provides a system, comprising: (a) an electronic storage unit having machine-executable code that implements any of the methods above, alone or in combination; and (b) a computer processor for executing the machine-executable code.

Another aspect of the invention provides an electronic data storage unit comprising machine-executable code that implements any of the methods above, alone or in combination.

Another aspect of the invention provides a media file management system (“system”) for enabling audio search, retrieval and importation. The system can automatically scan one or more email accounts for emails that have one or more audio files, such as MP3 files, WAV files, or other types of audio files. Next, the system imports the audio file into a storage location, which can include a special holding directory, on an electronic storage location of a central server. The system can modify the audio file during or subsequent to importing the audio file, such as by converting or modifying the audio file from one format to another. In some situations, the audio file can be modified by removing a header of the audio file. In other cases, the audio file can be modified by altering or substituting the header of the audio file. Next, the system can generate a list of audio files that have been retrieved by the system from emails and imported by the system into the storage location. The system can subsequently make the list available for viewing by users or select users. In some situations, a list widget can be used to view the list. The list widget can be part of a user interface (UI), such as a graphical user interface (GUI), of the system. The list widget can be part of the system, such as a system module, or another system in communication with the system.

The system can allow a user to harvest (or ingest) an audio file, generate metadata for the audio file, and prepare a media asset associated with the audio file for use in broadcast content. The media asset in some cases is a copy of the audio file that is ready for use with broadcast content. In some cases, the audio file may not be included in the media asset, but a link to the audio file may be provided in the media asset, such as by way of metadata having the location of the audio file. The metadata may include information about the email and audio file.

In some cases, once the media asset has been committed for use (e.g., for use in a commercial, advertisement or program), the media asset may no longer be visible in the list. Alternatively, once the media asset has been committed for use, the media asset may be kept for future use, such as in another storage location.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a method for importing a media file, in accordance with an embodiment of the invention;

FIG. 2 shows an email accounts configuration user graphical interface (GUI), in accordance with an embodiment of the invention;

FIG. 3 shows an account editing GUI, in accordance with an embodiment of the invention;

FIG. 4 shows a GUI with a list of media assets, in accordance with an embodiment of the invention;

FIG. 5 shows an example of various data displayed with a media asset, in accordance with an embodiment of the invention;

FIG. 6 shows a GUI for a system in which a traffic interface is not enabled, in accordance with an embodiment of the invention;

FIG. 7 shows a media file management system, in accordance with an embodiment of the invention;

FIG. 8 schematically illustrates a media asset, in accordance with an embodiment of the invention;

FIG. 9 shows an example of a method for using ingested audio files with the aid of a dub list widget;

FIGS. 10-16 are screenshots associated with the workflow of FIG. 9; and

FIG. 17 shows metadata that can be provided from a harvested media file having an ID3 tag.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed in practicing the invention.

The term “metadata,” as used herein, refers to data or information about other data. Metadata (also “meta data” herein) may be included in, or associated with, a file, such as an audio file.

The term “media asset,” as used herein, refers to a media file (e.g., audio file, video file) that is ready for use with broadcast content, such as a commercial spot. A media asset refers to a media file that has been imported (or ingested) from an email to an electronic storage location, and in some cases processed for use with broadcast content. A media asset is ready for use with broadcast content without any additional processing. In some examples, a given media asset can be combined with broadcast content to prepare a commercial for broadcast. The media asset in such cases can provide audio for use with video content in preparation of the commercial. A media asset can be used in Internet, radio or television broadcast content.

The terms “harvest” and “ingest,” as used herein, refers to downloading or otherwise retrieving a media file from an email.

In some situations, a media asset can be presented to a user by way of an electronic object that may include one or more textual information about a media file (e.g., audio file), textual information about an email having the media file, and links to one or both of the email and media file. In some instances, a media asset collectively refers to a media file, email and associated metadata.

The term “electronic mail” (also “email”, “e-mail” or “e.mail”), as used herein, refers to an electronic communication that can be a digital message from a sender to one or more recipients. An email can include one or more of textual information or media content, such as images, audio files and/or video files. Email can operate across the Internet or other computer networks.

The term “broadcast content,” as used herein, refers to commercials, advertisements and/or programs for broadcast over a broadcast medium, such as over the radio, the Internet, or a television network.

The term “commercial spot,” as used herein, refers to a commercial for broadcast over a broadcast medium, such as over the radio, the Internet, or a television network. A commercial spot can be broadcast or otherwise distributed by a broadcaster.

The term “broadcast content scheduler” (also “content scheduler”), as used herein, refers to a user or entity that schedules content to be broadcast. An example of a broadcast content scheduler is a media sales, traffic and billing system, such as an automated radio traffic management system (e.g., WideOrbit traffic) that can schedule commercials and/or other programming material for broadcast over the radio, or an automated music scheduler that schedules music for broadcast. A broadcast scheduler can select a distribution list (e.g., radio station) for broadcast. Another example of a content scheduler is a music scheduler.

The invention provides systems and methods for harvesting a media file (e.g., audio file) from an email and in some cases committing the media file for use with broadcast content, such as a commercial. The media file can be embedded in or attached to the email. A harvested media file can be imported and associated with broadcast content.

Media files can be image files, audio files, and/or video files, and they can have various formats. Audio files, for instance, can include WAV, MP3 or MP4 files. An email directed to a recipient may include a sound or music file that is typically manually imported by a user into an electronic storage unit (or location), such as a hard drive or a database. Manually importing tens, hundreds or even thousands of audio files may take a considerable amount of time and effort.

Methods for Importing Media Files from Emails

An aspect of the invention provides method for ingesting media files from emails and preparing the ingested media files for use with broadcast content. The method comprises using a media file management system (the “system,” see below) or a module of the system to search electronic mails for one or more media files attached to or embedded in the electronic mails (“emails”). In some embodiments, the emails are designated for use with broadcast content, such as a commercial. In some example, emails are designated for use with broadcast content by text in a Subject field of the email (e.g., “Audio file to use with tomorrow's 10 AM commercial”). Media files found in or attached to an email can then be imported by the system to a file repository, and an imported media file can be subsequently processed, such as by modifying a header of the media file (e.g., modifying or replacing an audio file header). A media asset can be formed having metadata that includes information about the email and the media file that was ingested by the system. The media file can be an image file, video file, or audio file. In some embodiments, the media file is an audio file.

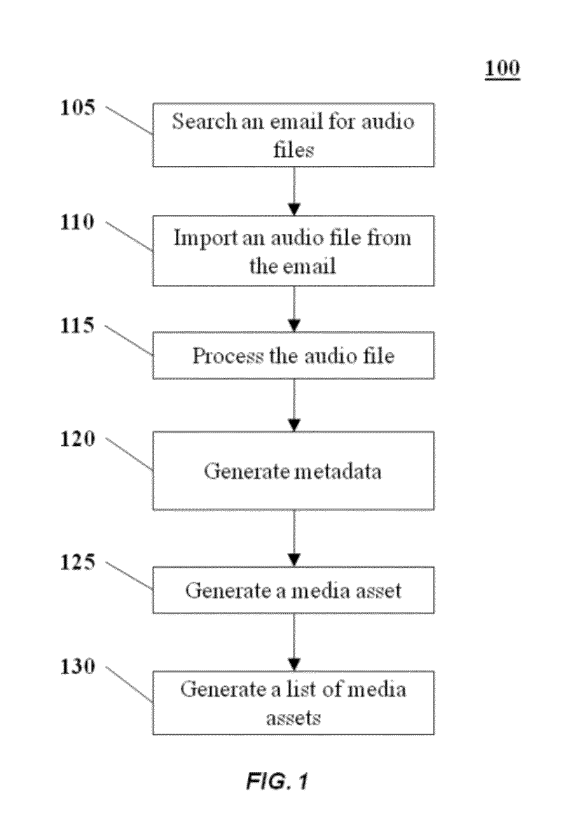

FIG. 1 shows a method 100 for importing an audio file from an email, in accordance with an embodiment of the invention. The method 100 can be used to import other media files, such as image files, text files, or video files. In a first step 105, the system accesses an email account on a computer server (“server”) hosting the email account and conducts a search of an email for one or more audio files, which may be attached to or embedded in the email. The system conducts the search automatically, or upon request by a user. The search can be conducted at predetermined time intervals, such as in a batch-wise fashion, or as emails arrive at a predetermined or designated server. In the latter case, the system can search emails for audio files as the emails arrive on a server hosting

In some instances, the search can be conducted by scanning email messages in an email repository (or “inbox”). In other instances, the search can be conducted by scanning various email accounts, such as those included in a configuration file or provided by a user. For example, a user can provide the system a list of email accounts (e.g., Gmail account, Yahoo account, Facebook account, Microsoft® Exchange account) to access and search for audio files.

Next, in a second step 110, the system imports an audio file from the email. The audio file can be found by the system in search step 105. The audio file can be imported into a storage location or file repository (e.g., database), as described below.

Next, in a third step 115, the audio file is processed by the system. The audio file can be processed by modifying the audio file, such as by removing headers (e.g., MP3 headers). In other cases, the audio file can be converted from one audio format to another. For example, the audio file is converted from an MP3, WAV or AVI audio format to an audio format (e.g., a proprietary audio format) for insertion into other media files, such as commercials, advertisements or programs for broadcast. In some cases, the audio file can be converted by removing a header from the audio file, or by altering the header of the audio file. The audio file can be converted to an audio format recognizable by a system for generating media content (e.g., advertisements, commercials, programs).

Next, in a fourth step 120, the system generates metadata or retrieves metadata for use with a harvested audio file. In a fifth step 125, after metadata has been generated or retrieved, a media asset is generated. With a media asset generated, an imported media file, which in some cases may be processed following importation, is ready for use with broadcast content. In some cases, the email body and the audio file(s) that were harvested are purged from a temporary directory having the email body and audio file(s), though in other cases they are retained for verification purposes (see below). In some situations, if a content scheduler is used, the system can send a notification to the content scheduler that the committed media file (hence media asset) has been created and is ready for use. In such a case, the content scheduler may not prompt the user to create a media asset.

In some cases, metadata can have information relating to the audio file and the email that included the audio file. The system can retrieve metadata from the audio file, such as, for example, an ID3 tag of an MP3 audio file. Metadata can be retrieved from the audio file and/or content scheduler, or manually entered by the user. In cases in which a content scheduler is used, metadata can be provided by the content scheduler. In cases in which a content scheduler is not user, metadata can be manually entered by the user.

In a sixth step 130, the system generates a list of ingested media files (or media assets) for display to a user. In some cases, the media asset list includes graphical items in which each item includes information relating to a media asset, such as, for example, the name of the media file, when the media file was received in an email, an electronic link (“link”) to the original email and a link to the media file. In some situations, the media asset can include a link to preview the audio file (see below). The list can include indentifying information of the media file and the email from which the media file was imported, which can be used for verification purposes, such as if a user wishes to verify that a particular media file is to be used with certain broadcast content.

In some situations, information relating to a harvested audio file and an email from which an audio file was imported (step 110) is presented to the user in the list so that the user can verify that the audio file selected by the user is the media file that the user wishes to user with a particular spot. Such verification can come at a point in which the user is reviewing a list of media assets to determine whether any media asset in the list is appropriate for use with a particular broadcast content. Verification information can include one or more of the file name of the audio file, the length of the audio file, the compression type of the audio file, a timestamp in which the audio file was imported, a timestamp in which the email having the audio file was received, the subject of the email, the body of the email, the sender of the email (e.g., name of sender, email address of sender), the recipient of the email (e.g., recipient name, email address), a location where the original email is stored, a location where the original audio file is stored, and a location where the converted audio file is stored. The metadata can include a path to the audio file. The path can be a system path or an Internet path, for example, in cases in which audio files are stored on a remote computer. In some cases, the user can listen to the audio file and view the email to verify that the harvested audio file, now media asset, is to be used with certain broadcast content. Such broadcast content can be schedule for use by a traffic system.

The system can generate a list of ingested media files automatically or upon request by a user, such as upon a user search for media assets. The list can include one or more audio files generated in accordance with the user's search query, or media assets that can be relevant to a commercial, advertisement or program being dubbed.

In some cases, the system or a user can update or otherwise modify metadata associated with a media asset when the user has selected the media asset for use with broadcast content and the system is associating the media asset with the broadcast content. In an example, the user elects to use metadata provided by an audio file (e.g., ID3) tag with a media asset selected for use with a selected broadcast content.

The user can access the list to select one or more media assets for use in preparing a commercial, advertisement or program. In an example, the user selects a media asset having audio content for inclusion in a commercial for radio broadcast.

### Media File Management Systems

In another aspect of the invention, a media file management (“system”) includes a central computer server (“server”) that can include a media importer for scanning file transfer protocol (FTP) sites, local folders, or email accounts for media files, such as, for example, audio files. The media importer may then import media files found in the FTP sites, local folders or email accounts into a media library of the system. In an example, the media importer accesses an email account on a server and retrieves audio or video files from an email on the email account. The media importer can provide the imported media files to a list widget of the system, which generates a list of the media files imported from an email account.

In some cases, once an audio file is imported from an FTP site, local folder or email account, it may be processed according to one or more rules. A user may elect a rule from predetermined rules, input a new rule, or modify a predetermined rule. A rule may define the manner in which the system processes an audio file. In some instances, a rule may govern details concerning the distribution and/or broadcasting of a media asset, such as the date a media asset may be broadcasted or which media distributor (e.g., radio station) is permitted to broadcast the media asset.

The system may include various modules communicatively coupled to the central server. For instance, the system may include one or more electronic storage modules or file repositories (e.g., database) in communication with the central server for storing retrieved (or imported) audio files. The central server may be in communication with a media importer module, which may search for and retrieve audio files from predetermined (or user-defined) locations. In some cases, the system may include a metadata module for generating metadata associated with a retrieved audio file. Each module may be a standalone system, software in the system, or an operating system component.

Systems provided herein include various hardware and software. In some embodiments, a media file management system includes a central processing unit (also “computer processor” and “processor” herein), memory (e.g., random-access memory and/or read-only memory), a communications interface, a data storage unit and, in some cases, an electronic display. The communications interface includes a network interface for enabling a system to interact with an intranet, including other systems and subsystems, and the Internet, including the World Wide Web. The data storage unit includes one or more hard disks and/or cache for data transfer and storage. The data storage unit can include one or more databases, such as a relational database. In some cases, the system further includes a data warehouse for storing information, such user information (e.g., profiles) and results, and/or metadata. In some cases, the data warehouse resides on a computer system remote from the system, such as in a different building, which may be in a different city, region or country. In some embodiments, the system can include a relational database and one or more servers, such as, for example, data servers. The system can include one or more communication ports (COM PORTS), one or more input/output (I/O) modules, such as an I/O interface. The processor may be a central processing unit (CPU) or a plurality of CPU's for parallel processing.

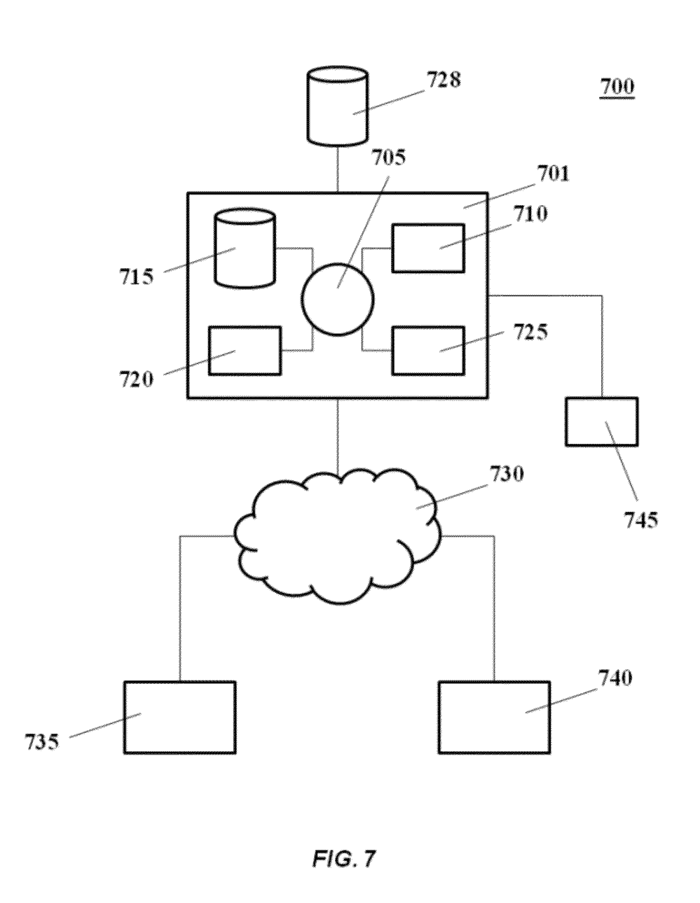

FIG. 7 shows a media file management system 700 having a central server (“server”) 701, in accordance with an embodiment of the invention. The server 701 is configured to implement the methods of the invention. The server 701 includes a CPU (or processor) 705, which can be a single core or multi core processor, or a plurality of processors for parallel processing. The server 701 also includes memory 710 (e.g., RAM, ROM, flash memory), electronic storage unit 715 (e.g., hard disk), electronic communications interface 720 (e.g., network adapter) for communicating with one or more other systems, and peripheral devices 725, such as cache, other memory, data storage and/or electronic display adapters. The storage unit 715 can be a data storage unit (or data repository) for storing data. The components of the server 701 are in communication with the CPU 705, such as through a communications bus (e.g., motherboard). The server 701 is operatively coupled to a computer network (“network”) 730 with the aid of the communications interface 720. The network 730 can be the Internet, an internet and/or extranet, or an intranet and/or extranet that is in communication with the Internet. The network 730 can include one or more computer servers, which can enable distributed computing.

The server 701 can include an additional data storage unit 728 for storing files (e.g., image files, audio files, and/or video files) from email attachments. The data storage unit 728 can be external to the server 701, such as located on a remote server that is in communication with the server 701 through an intranet or the Internet. In an example, the data storage unit 728 is an external database. In some situations, the data storage unit 728 can be used to backup data from the storage unit 715, such as, for example, in a redundant array of inexpensive disks (RAID) setup.

The server 701 can communicate with one or more remote computer systems through the network 730. In the illustrated example, the system is in communication with a first remote computer system 735 and a second computer system 740.

Methods of the invention can be implemented by way of machine (or computer processor) executable code stored on an electronic storage location of the server 701, such as, for example, on the memory 710 or electronic storage unit 715. During use, the code can be executed by the processor 705. In some cases, the code can be retrieved from the storage unit 715 and stored on the memory 710 for ready access by the processor 705.

In an exemplary implementation of the server 701, the server 701 can access one or more email accounts on the first computer system 735 and/or second computer system 740 to scan (or search) emails for files as attachments. The server 701 can then download any files (e.g., audio files) revealed in the search and store the files in the storage unit 715, data storage unit 728, or both. The server 701 can also generate media assets associated with the files, and store the media assets in the storage unit 715 and/or data storage unit 728.

The system 700, including the sever 701, can be in communication with one or more automated broadcast content schedulers, each of which is configured (or programmed) to schedule broadcast content (e.g., commercial spots). In the illustrated example, the server 701 is in communication with an automated broadcast content scheduler 745. In an example, the automated broadcast content scheduler 745 is an automated radio traffic management system that is adapted to schedule content (e.g., commercial spots) for broadcast over the radio. The automated broadcast content scheduler 745 can be in communication with the server 701 either directly, as illustrated, or though the network 730.

In some cases, the server 701 can be configured for data mining and extract, transform and load (ETL) operations, which may permit the system to load information from a raw data source (or mined data) into a data warehouse. The data warehouse may be configured for use with a business intelligence system (e.g., Microstrategy®, Business Objects®). The media file management system can include a data mining module adapted to search for media content in various source locations, such as email accounts and various network sources, such as social networking accounts (e.g., Facebook, Google+, Linkedin).

Aspects of the systems and methods provided herein, such as the server 701, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., ROM, RAM) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

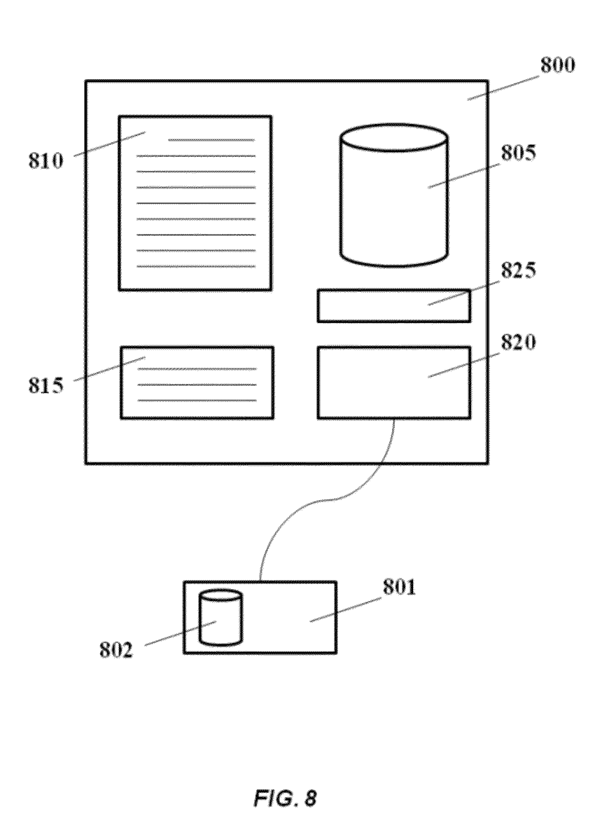

FIG. 8 schematically illustrates an electronic object 800 that is adapted to display information relating to a media asset to a user. The electronic object can be a graphical item for display on a graphical user interface (GUI). In some cases, the object 800 is displayed to a user in a list of media assets. The electronic object can be formed with the aid of the system 700 of FIG. 7 and displayed to the user with the aid of an electronic display and a GUI presented on the display. The object 800 can enable the user to verify information of or related to a media file harvested from email.

The object 800 can include information relating to an email 801 having a media file 802 as an attachment. The object 800 includes a link to a media file 805, a body 810 of the email 801 from which the media file 805 was retrieved by the system, and other information 815. The media file 805 can reside in an electronic storage unit of the system, and can be a media asset ready for use with broadcast content. The link to the media file 805 can be included in the object 800 as a network link or path (e.g., system or network path), such as a path to the storage location of the media file in an electronic storage unit of the system. The other information 815 can be related to the email 802, such as, for example, timestamp associated with when the email is received at the recipient email account, timestamp of when the email is accessed by the system, timestamp of when the media file 805 is retrieved by the system, and information of or related to the media file (e.g., media type, compression type, runtime, sample rate).

The object 800 can include broadcast content information 825 related to any broadcast content selected for use with the media file 805. In an example, when the media file 805 has been selected for use with a given broadcast content (e.g., commercial spot), the object 800 is updated (or, alternatively, a new electronic object is formed) to include information related to the selected broadcast content. Such information can be included in the broadcast content information 825. Updating the object 800 can include updating the metadata of the object 800.

In some embodiments, the media file 805 is a copy of the media file 802 attached to the email 801. The object 800 also includes a link 820 to the email 801. The link 820 can include a file or system path to the email 801. The link 820 can enable the system or a user to access the email 801 from the object 800.

### User Interfaces

Another aspect of the invention provides user interfaces that enable users to interact with a media file management system, including a central server of the system. Such user interfaces are adapted for use with systems provided herein, such as the server 701 of FIG. 7. In some cases, a user, with the aid of a user interface (UI), can select the manner in which the system searches email accounts and retrieves media files, such as, for example, audio files as email attachments. The UI can enable the user to select a file location to be searched for media files, select an account to be searched, define a new email account to be searched, edit an existing email account, and delete an existing email account. The UI can also permit the user to view and, in some cases, modify a media asset.

The system UI can enable a user to configure the system, including the central server, such as the central server 701. The UI may be a graphical user interface (GUI) for enabling a user to access the system, including the central server, with the aid of a remote terminal (e.g., laptop computer, desktop computer, smart phone, tablet or slate personal computer). The GUI can enable the user to select one or more locations to search for email attachments, such as one or more email accounts. The user can also select or modify rules criteria for a search. The GUI can include a central server configuration module for providing a user access to various central server parameters, such as search parameters and modification rules.

In some cases, the GUI enables the user to interact with the media file management system from a remote computer system that is in communication with the media file management system through a network. The user can access the media file management system from the remote computer system and, with the aid of the GUI, select one or more media assets to view and/or include in a commercial or program, which can be for broadcast over the radio, internet, or a television network.

In some embodiments, a user interface includes a graphical user interface (GUI) that enables a user to define a new email account to be scanned by the central server of the media file management system. In such a case, the system can provide the user a GUI to access the central server via a central server configuration GUI and navigate to a media importer module, such as by selecting a media importer link from the central server configuration GUI. The media importer link can include an email accounts section or tab, which can enable a user to add (or create) a new email account for searching. The new email account may be included in a list of email accounts to be searched.

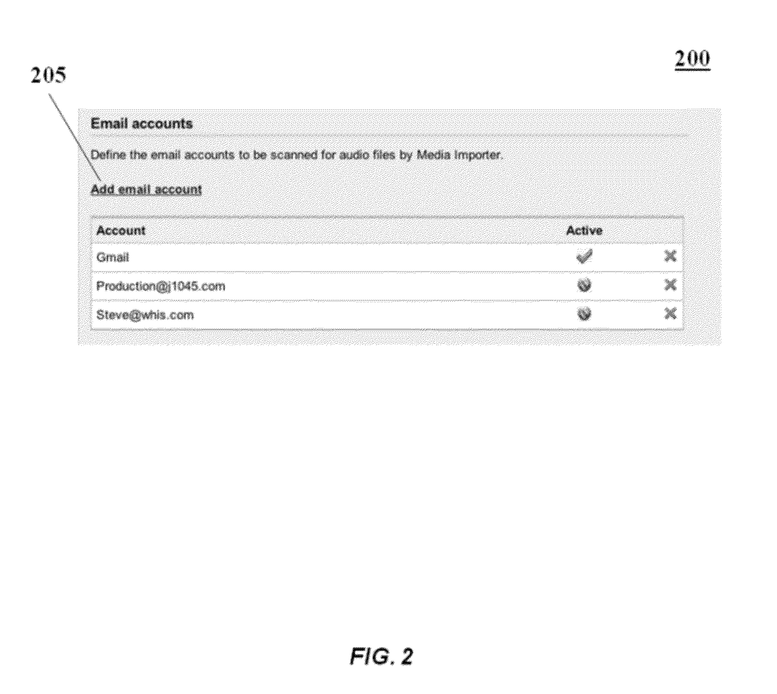

FIG. 2 shows an email accounts configuration GUI 200 for enabling a user to input one or more email accounts to be searched for audio files by the system. The configuration page GUI includes an “Add email account” hyperlink (also “link” herein) 205 for enabling a user to add new email accounts. In the illustrated example, two email accounts have been included in a list of email accounts to be searched, “Steve@whis.com” and “Production@j1045.com.” The system can enable the user to remove an email account. As illustrated, a user can remove one or both of the email accounts by clicking on the “X’ link associated with each of the email accounts.

A user can select the “Add email account hyperlink” to provide a new email account for a search. The system can provide the user an input field for providing email server configuration information and login credentials for an email account to be added.

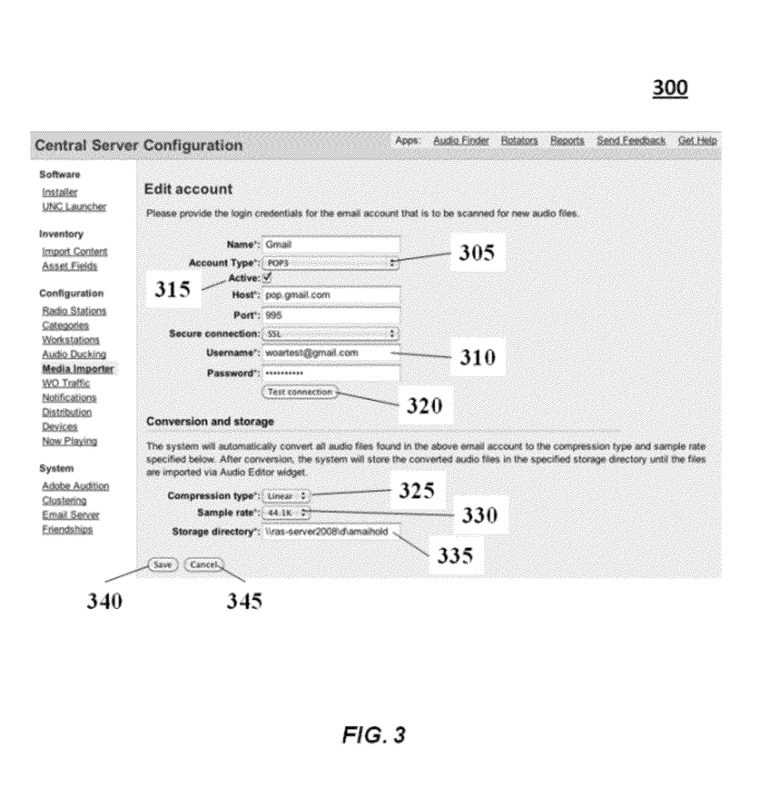

FIG. 3 shows an account editing GUI 300 for enabling a user to define a new email account. The account editing GUI can include an “Account type” drop-down menu 305 in which a user can select the type of email system associated with the account. The system can be configured to scan emails on various types of email servers. For instance, the system can be configured to scan emails on a Microsoft® Exchange Server (e.g., 2003, 2007 and 2010 Exchange releases), a POP3 server, an IMAP server, or a Google® Apps sever. In some example, the system can scan personal email accounts or social network accounts, such as a Gmail account, Yahoo account, Microsoft mail account, or Facebook account. The user can elect to input the account type from a drop-down menu. For instance, the user can select a Microsoft® Exchange, POP3, IMAP or a Google® Apps account.

The account editing GUI 300 further includes an “Email address” field 310 for a user to provide or input an email address to be scanned. An “Active” check box 315 designates whether the system will scan the email account. If the check box 315 is not checked, the system will not scan the email account for emails and media file attachments. A “Test connection” button 320 can permit the system to test the connection to the email server and verify the login credentials associated with the new email account. In some cases, when a user inputs an email account to be searched, the system (e.g., central server 701) can verify the email account, such as by transmitting a verification email and requesting that the recipient send a confirmation email or follow a confirmation hyperlink.

The system may scan email accounts for media files (e.g., audio files) in a sequential basis by accessing email accounts provided in a list of email accounts and checking each email account sequentially. Alternatively, the system can access and search all email accounts in a list of email accounts simultaneously.

The account editing UI 300 further includes a “Compression type” drop-down menu 325 for enabling a user to select a compression type of an imported audio file. For example, a user can select a “Linear” compression type (which may be the default choice), MPEG 1 Layer 2 (MP2), MP3, WAV compression types. The account editing UI 300 also includes a “Sample rate” drop-down menu 330 for enabling a user to select a sample rate for the imported audio files. Sample rates may be between 16 kHz and 96 kHz. Sample rate options may include, for example, 32 kHz, 44.1 kHz and 48 kHz. A “Storage directory” field 335 may enable a user to input a storage location of a media file after the media file has been retrieved and imported from an email. This field can accept universal naming convention (UNC) paths (e.g., “\\server\share\directory”), Internet paths, or a local system path (e.g., “\\user\home” or a local system path, such as “c:\directory”).

With continued reference to FIG. 3, the UI 300 includes a “Save” button 340 such that a user can validate and save all inputted data to the system. Upon request by the user, the system may validate the inputted data by accessing the email account, or transmitting a verification message to the user. The information provided in the UI 300 can be saved to a diagnostic log of the central server of the system. A “Cancel” button 345 can enable a user to cancel defining a new email account to be searched for audio files.

The UI 300 can include a navigation bar for enabling a user to access various modules of the system. A navigation bar toward the left of the screen allows a user to access, among other things, a “Radio Stations” module, a “Categories” module, or a “Workstations” module.

The system, including UI, enables a user to edit an existing email account configuration. The user can access the central server configuration (via a central server configuration UI, for example) and navigate to the media importer module. The user can navigate to the email accounts section of the screen and select an existing email account from a list of one or more email accounts. The system can display the details of the selected email account to the user. The user can edit any field associated with the selected email account, such as any of the fields of FIG. 3. The user can save all of the user's edits or changes, or cancel all edits or changes. The user can then be returned to the UI for the media importer. Changes made to one or more of the email accounts can be saved to a diagnostic log of the central server of the system.

The system can enable a user to delete an email account from the media importer. The user can access the central server configuration and navigate to the media importer module. The user can navigate to the email accounts section having one or more email accounts in a list of email accounts. The user can select an “X” on a right side of an email account desired for deletion. The system can prompt the user for confirmation as to deleting the selected email account (e.g., “Are you sure you wish to delete this email account? This action cannot be undone.”). The user can select from either a “Yes” or “No” option. If the user selects the “Yes” option, the email account will be deleted from the system. For example, the email account can be deleted from a configuration or data file of the media importer. If the user selects the “No” option, the system can return the user to the email accounts section having the list of email accounts. Changes made to the list of email accounts can be saved to a diagnostic log of the central server of the system.

### Methods for Scanning Email Accounts for Media Files

Another aspect of the invention provides methods for scanning email accounts for media files attached to, or embedded in, emails. In some embodiments, during use, a central server of a media file management system (e.g., the system 700 of FIG. 7) may access an email account and search for media files. The email account in some cases is accessed upon verification, as described elsewhere herein. In some cases, the central server includes a media importer that can access an email account provided in the list of email accounts at a predetermined frequency, such as at least every 1 second, 5 seconds, 10 seconds, 20 seconds, 30 seconds, 40 seconds, 50 seconds, 60 seconds, 2 minutes, 10 minutes, 20 minutes, or 30 minutes.

A search can be conducted for at least one valid email account. In a first step, the central server scans each email account and all email received within a predetermined period of time for media file attachments and embedded media files (e.g., audio files). In some cases, the system searches all emails received in the last one, or two, or three, or four, or five, or six, or seven days. Next, if any of the attachments do not have a predetermined or otherwise recognized media file, such as an MP2, MP3, WAV, AIFF, AU, PCM, FLAC, or WMA audio file, the system may terminate the search for a predetermined period of time, such as between about 10 seconds and 1 minute. Otherwise, the system may import the body and the sender address of the email with the media file into a storage unit of the system, such as a file repository. This information can be imported to a data file, or a memory location of the system or module associated with the system. The media file can be stored in a predetermined storage location. Next, the system can retrieve the timestamp (data and/or time of receipt) associated with when the email is searched. The system may then import all media files provided as attachments or embedded in the email, and in some cases retrieve and save the timestamp associated with when each media file is imported.

The system can then convert the media file from one format to another. For example, the system may use an audio toolbox to convert an MP3 or WAV audio file to a file having a resource interchange file format (RIFF) or WAVE (or WAV) file format that may include proprietary data. In some situations, the proprietary data can include a proprietary media header, such as a proprietary audio header. In some cases, the system may convert an MP3 or WAV file to a file format for use with various system, sub-systems and modules. Such a file may be accessed on standard players (e.g., Apple® iTunes or Windows® Media Player), which may ignore proprietary data. In some cases, the system may convert the file to the compression type and sample rate specified above. If the conversion is not successful, the system may notify the user and provide the user the option to retry the conversion.

Alternatively, the system can convert the media file to a proprietary file format. For example, the system can convert an MP3 or WAV audio file to a file format that is proprietary to the organization hosting or managing the central server of the system. The proprietary file format can have a compression that is specific to the proprietary file format. In some cases, the proprietary file format has a proprietary header. The system can convert a media file to a proprietary format by modifying a header of the media file to include the proprietary header.

The system can retrieve (or harvest) from email, convert and store a media file on the central server (e.g., data storage unit of the central server) or a file repository (or database) associated with the central server and in a directory specified by the user. The media file can be converted automatically by the system, such as upon the system importing the audio file into a data storage unit of the system (e.g., storage unit 715). Alternatively, the system can retrieve and store the media file on the central server or the file repository, but not convert or otherwise modify the media file.

A media file can be stored on the central server until it is requested by a user. In some cases, the user can request the media file with the aid of a list widget (see below).

The email body and other details of the email having the media file (or media file attachment) can also be stored on the central server. The email body can be stored in a data file of a data storage unit of the central server, or a data storage unit associated with the central server. In an example, the email body is stored in a text file stored on a data storage unit of the central server.

In some cases, the email body and other details can survive a restart of the central server. In an example, the system, including the central server, includes an email data log that incrementally stores emails searched, including the bodies of the emails. This enables the system to retrieve such information upon system shutdown, such as an intended shutdown or a system crash.

In some instances, the system can remember (e.g., with the aid of system cache, memory or data storage unit) details about a media file that has been harvested from an email but not yet used by the list widget. This can permit the system to present the user with the media file if the central server is restarted before the user can use the list widget.

The email body and other details of the email can be stored on the central server until they are requested by a user. In some cases, a user can request the email body and other details of the email with the aid of a list widget.

The storage location of a media file, changes made to the media file and the storage location of the email body and other details of the email can be saved to a diagnostic log of the central server of the system. This can aid in system troubleshooting.

### Media Lists

Another aspect of the invention provides media lists to enable a user to view (or listen to) and use a media file that is retrieved from an email. A media list can include a list of media assets. Each item in the list can include an electronic object, as described above in the context of FIG. 8.

A media list can display media assets, which can include metadata of or related to a media file that was retrieved from an email, and information relating to the email, such as the textual content of the email.

In some embodiments, a system generating media lists, such as the system 700 of FIG. 7, can provide dub list widgets to enable various functions, such as viewing and editing media assets presented in media lists.

A media list is presented to a user with the aid of a list widget and is configured for use with systems provided herein. In some embodiments, a media list presents to the user a list of all media assets prepared by the system with media files from emails.

In some cases, the system (e.g., the system 700 of FIG. 7) presents a media list to a user. The user may view a media asset on the media list and subsequently use the media asset with commercial or other programming material provided by a broadcast content scheduler, such as a media sales, traffic and billing system (e.g., WideOrbit Traffic) that is communicatively coupled to the system. The media sales, traffic and billing system can schedule broadcast content for broadcast, such as commercial content, program content and/or music content. The system can communicate with one or more media sales, traffic and billing systems (also “traffic systems” herein) with the aid of a traffic protocol, as can be implemented through a communications interface of the system. Such traffic systems can provide advertising material, including commercials, for use with media assets and/or media files retrieved as attachments from emails. Systems provided herein may be used to edit such advertising material with media files retrieved from emails and presented to a user through a media list. Such sales, traffic and billing systems can be configured for use with various media file types, such as image files, audio files, and/or video files.

In an example, a user wishes to supplement a commercial retrieved through an audio sales, traffic and billing systems with one or more audio files. The system 700 presents the user with a media list having one or more media assets. The media list can be presented to the user through a GUI having the list. The user selects a media asset having an audio file that the user intends to use in the commercial. The system enables the user to edit the commercial to include the audio file, which can be subsequently broadcast.

Some embodiments provide methods for using media lists to select media assets for use in programming content. Such programming content can be provided through traffic systems. In a first step, the system determines whether a traffic interface of the system is enabled. In some cases, the system can proceed to the next step only if the traffic interface of the system is enabled. In a second step, the system provides the user a list of one or more commercials or other broadcast content. The user can select a commercial that the user wishes to use. In a third step, the system asks the user if the user desires to import a media file (e.g., audio file) from a list of media assets, which were prepared from media files harvested from emails (e.g., “Do you wish to import the audio from email?”). A list of media assets can be presented to the user, and the user can verify information of or related to the media assets. The list of media assets includes electronic objects relating to individual media assets, as described in the context of FIG. 8. For instance, the system can present the user with a media list having media assets that have been prepared from media files harvested from emails. If the user elects to not import a media file, the system will not proceed to the next step. If the user elects to import a media file from a media asset, the system will associate the media asset with the commercial and subsequently remove the media asset from the list.

In some situations, if a single email contained more than one media file, each media file can be listed as a separate media asset. Alternatively, the system can group media assets based on various criteria, such as email of origin, genre, artist, type of music, type of video, type of media file.

In some embodiments, the system can enable a user to associate harvested media files with broadcast content in cases in which the system does not have a traffic interface. In such a case, the user can manually select broadcast content from various sources and associate such selected broadcast content with a selected media asset formed from harvested email.

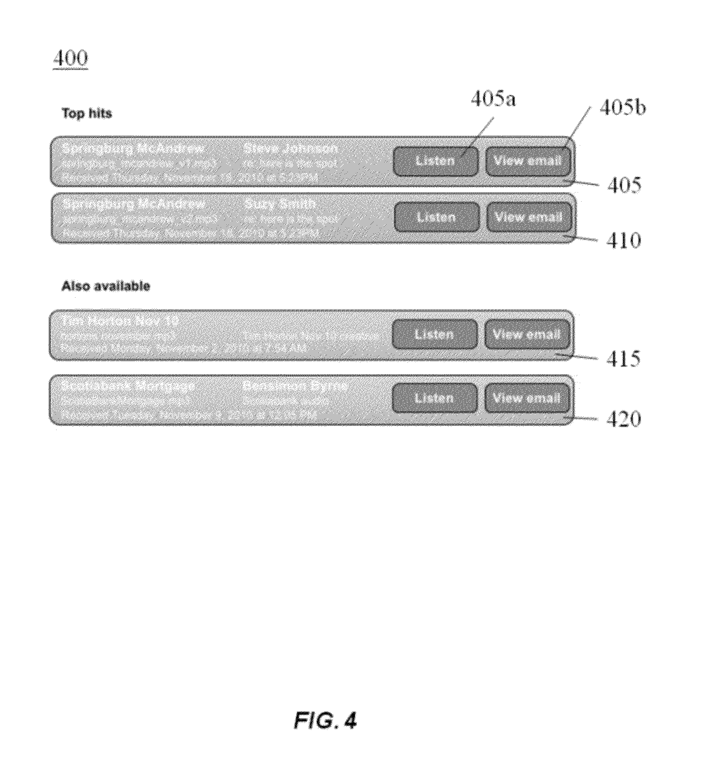

FIG. 4 shows a graphical user interface (GUI) 400 having media assets 405, 410, 415 and 420. Each media asset can include metadata having a location of a media file associated with the media asset, the source of the media file (e.g., audio file), the timestamp the media file was retrieved, the timestamp the email having the media file was searched by the system, the subject of the email, the sender of the email and the recipient of the email. Media assets 405 and 410 are associated with “Springburg McAndrew” audio files (or “spots”) that were retrieved from an email with subject “re: here is the spot”. A user may listen to a media file or read an email associated with each media asset. The media assets of FIG. 4 have not yet been associated with broadcast content.

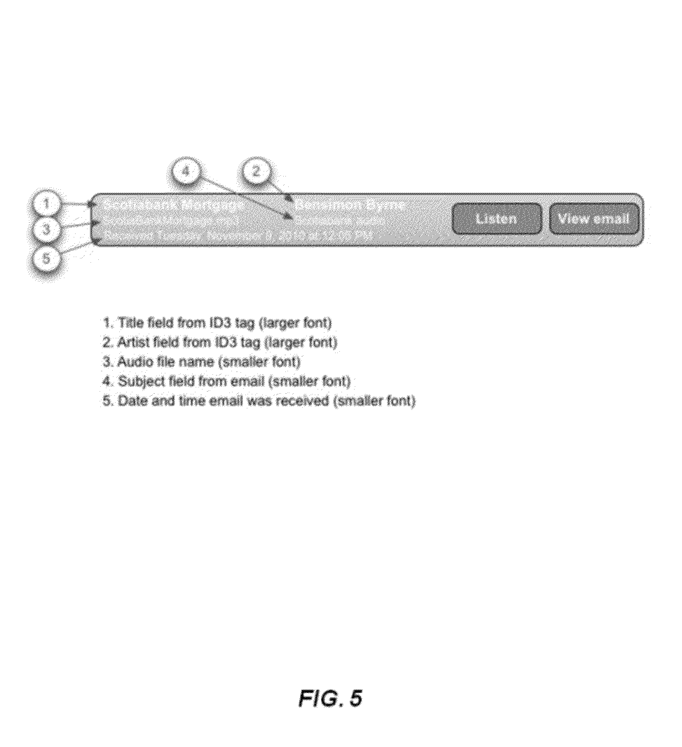

A media asset can include metadata for providing various information relating to a media file and an email that provided the audio file. As an example, FIG. 5 shows various data (or metadata) displayed with a media asset. The illustrated media asset may include a title field (1), an artist field (2), a media file name (3), a subject field (4), and a date and time (“timestamp”) the email was received 5. The subject field (4) can be the subject field of the email used to retrieve the audio file associated with the media asset.

A list can be organized in a plurality of sections. For example, a top hits list can be the most likely or most desirable audio files for the commercial selected to be dubbed. The system can populate the top hits list by comparing an advertiser name from a media sales, traffic and billing system with the title field of the audio file harvested from email and/or the subject field of the email. The system can also make available to a user a listing of all other audio files harvested from email but not yet imported. In such a case, the system can present the user with a media asset associated with the audio file but without an option to listen to the audio file.

Electronic objects associated with media assets can provide various uses and functionalities. In some cases, if a user presses a “Listen” button of an electronic object associated with a media asset, such as listen button 405a of FIG. 4, a preview widget is invoked and a preview of the audio associated with the media asset is provided to the user. In some cases, the audio file can be played in its entirety, but a user can elect to terminate listening to the audio file. If the user presses a “View email” button of an electronic object associated with a media asset, such as button 405b of FIG. 4, a slide-up widget can be invoked and the subject, from address, date/time received, and body of the email from which the audio file is harvested can be displayed. This information can display in the same window as the GUI 400 or in a separate window, such as a pop-up.

In some cases a file may not be successfully converted during media file importation from an email to a data storage unit of the system. A file that is not successfully converted may be of a type that the system is not capable of converting, such as, for example, an Ogg-Vorbis file. Alternatively, a file may not be successfully converted if the file is corrupted. A corrupted file may be a file that is ostensibly of a type that can be converted by the system (e.g., MP3 file), but the system was unable to convert because the file had various defects. In cases in which a media file was not successfully converted or is corrupted, upon invoking a listen button 405a, the system may display an error message (e.g., a “Bad file” error message). If the user tries to access the error message (e.g., “Bad file” error message) or elsewhere on the panel, another error message may be displayed (e.g., “This audio file could not be processed”). In some situations, despite the listen button not being functional, an “Email” button of a media asset may still present a user with various fields of the email used to retrieve the unconverted or corrupted audio file.

A user may select a media asset for use in dubbing or otherwise editing a commercial. For instance, the user may select any of the media assets of FIG. 4 for use in dubbing the commercial. In some cases, if the user touches the body (i.e., a location on the media asset that is not a button) of the media asset, the user selects the media file to be used for the commercial. Next, a dub list widget may spawn a media editor, which subsequently opens a timers tab. The dub list widget automatically imports the media file associated with the media asset and copies all metadata from a broadcast content scheduler, such as traffic. In situations in which the media file associated with the selected media asset includes metadata, a user may be given the opportunity to select metadata.

In some cases, when the user commits a media asset for use in a commercial or program, the media file and email, including metadata, associated with the media asset can be removed from the central server.

In some situations, systems provided herein may be used in cases in which a advertising material from a media sales, traffic and billing system (“traffic”) is not provided. For example, systems provided herein may be configured to retrieve, convert and import media files from emails in cases in which the systems do not communicate with traffic. For example, if the system does not communicate with traffic, the system may search emails and retrieve audio files and generate media assets, as described above. In an implementation, the system may not distribute or group media assets. For example, the system may not provide top hits. Such media assets can be used with commercial or programming material that may be available for use from systems other than traffic, such as commercial or programming material that may be stored on a data storage unit of the system. In cases in which a system does not communication with a broadcast content scheduler, the system can use metadata present in an imported media file (e.g., audio file) or metadata provided or otherwise manually entered by a user. In an example, a user provides metadata for an audio file using an audio editor of the system. In another example, the system imports an MP3 audio file from an email, and the MP3 file includes an ID3 metadata tag which is used by the system.

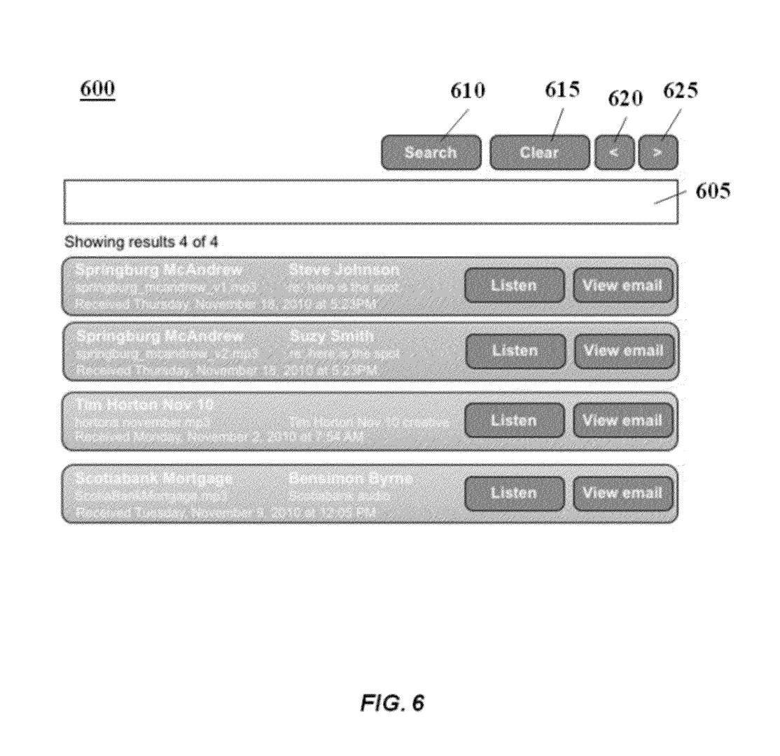

FIG. 6 shows a list widget presented by way of a GUI 600 having multiple media assets. The GUI 600 can be configured for use in cases in which the traffic interface is or is not enabled. The GUI 600 includes a search feature to enable a user to search for media assets. The GUI 600 includes a search box 605 for inputting a search string, a “Search” button 610 for invoking a search, a “Clear” button 615 for clearing a results list, and previous (“<”) 620 and next (“>”) 625 buttons for navigating through search results. A search for media assets may not produce any media assets matching a search criteria (i.e., no “hits”), or produce a single hit or a plurality of hits. As shown in FIG. 6, a single list can be generated without a “Top hits” or “Also available” category. In some situations, however, the system can provide a user a “Top hits” of media assets or rank (or order) media assets based on the media assets other users search for using certain keywords (or strings).

In some situations, the previous 620 and next 625 buttons can be used to view a list of media assets if the list is larger than the size of the display. If the list fits on the display, the previous 620 and next 625 buttons can be disabled. In other situations, the previous 620 and next 625 buttons can be used to navigate through different searches. For example, the previous button 620 can enable a user to view the results of a previous search.

In some cases, media assets in the GUI 600 can be listed in the order in which a media file was imported, with the media asset associated with the most recently-imported media file (e.g., audio file) at the top of the list.

A user can search for media assets by inputting one or more keywords and search strings. The system can then conduct a search of media assets stored in a file repository or database of the central server to find matches or best matches for the user's search criteria. In some cases, the system can search one or more fields described above in the context of FIG. 5.

The GUI 600 of FIG. 6 shows various media assets produced from a search by the user. Various metadata can be displayed for each media asset, as shown. The media assets and associated components in the GUI 600 can be as described above in the context of FIGS. 4 and 5.

Methods for Committing Media Files from Emails for Use with Broadcast Content

Another aspect of the invention provides methods for committing media assets for use with broadcast content, such as commercials. In some embodiments, a method for automatically ingesting media file attachments for use with a broadcast content comprises scanning, with the aid of a media file management system (e.g., the system 700 of FIG. 7), email in one or more email accounts for media file attachments corresponding to the broadcast content. The system can scan email by conducting a search of the email, such as, for example, on a sequential basis, which can include scanning emails as they arrive on an email account. Next, the system retrieves (or ingests) a media file attachment from the one or more email accounts into a data repository on a server. The ingested media file can be processed for use by the system, including use with broadcast content, and made available for use as a media asset. The system then generates a list of media assets for display on a graphical user interface (GUI) of a computer system communicatively coupled to the system, such as, for example, a remote computer system. Each media asset on the list is associated with a media file among the media file attachments. The system then commits a media asset from the list for use with the broadcast content. This can entail forming metadata associated with (i) the broadcast content and (ii) a media file associated with the committed media asset. In some embodiments, the metadata can include information related to the broadcast content (e.g., commercial) and the media file that was ingested from an email.

In some cases, prior to committing the media asset for use with the broadcast content, the system permits the user to verify that media asset. In an example, the user views the media asset on a list of media assets and reviews information relating to the media asset, such as the email from which a media file associated with the media asset was imported.

In some cases, a media asset is committed for use with a commercial spot by generating metadata having a name and a link to the commercial spot, in addition to a name of the media asset selected for use with the commercial spot. The commercial spot can be provided by an automated broadcast content scheduler, such as an automated radio traffic management system.

In some cases, the system receives a request from a user or another system for an automated broadcast content scheduler for use in providing broadcast content. The selected automated broadcast content scheduler can be a source of broadcast content intended for use with a media file provided through email and imported by the system, optionally processed, and subsequently stored on the system as a media asset. In some examples, the automated broadcast content scheduler is an automated radio traffic management system.

In some embodiments, the system combines metadata associated with the broadcast content with metadata associated with the media asset. Such combination can include generating new metadata or modifying existing metadata (see, e.g., FIG. 8 and related text). In an example, metadata associated with a media asset is modified to include indentifying information of the broadcast content.

In some embodiments, a method of ingesting media file attachments for commercial spot(s) automatically from electronic mail (email) comprises scanning email from one or more email accounts for media file attachments corresponding to commercial spot(s) and ingesting the media file attachments from the one or more email accounts into an electronic storage location located on a server. The ingested media file can be processed for use by the system, including use with broadcast content, and made available for use as a media asset. A graphical user interface is provided that displays a list having the media assets. Each media asset is associated with a media file imported from the one or more email accounts.

In some cases, the media assets are updated to include metadata corresponding to selected commercial spot(s). Alternatively, new media assets are formed for selected commercial spot(s) by combining metadata corresponding to the selected commercial spot(s) with metadata corresponding to the media file attachments selected from the list. In some cases, the one or more media assets for the selected radio commercial spot(s) are committed for broadcast, and the selected media file attachments and/or their media assets are removed from the displayed list.

In some cases, the media file attachments are converted for use with the commercial spot(s) as required upon importing of the media file attachments into the electronic storage location.

### Example 1

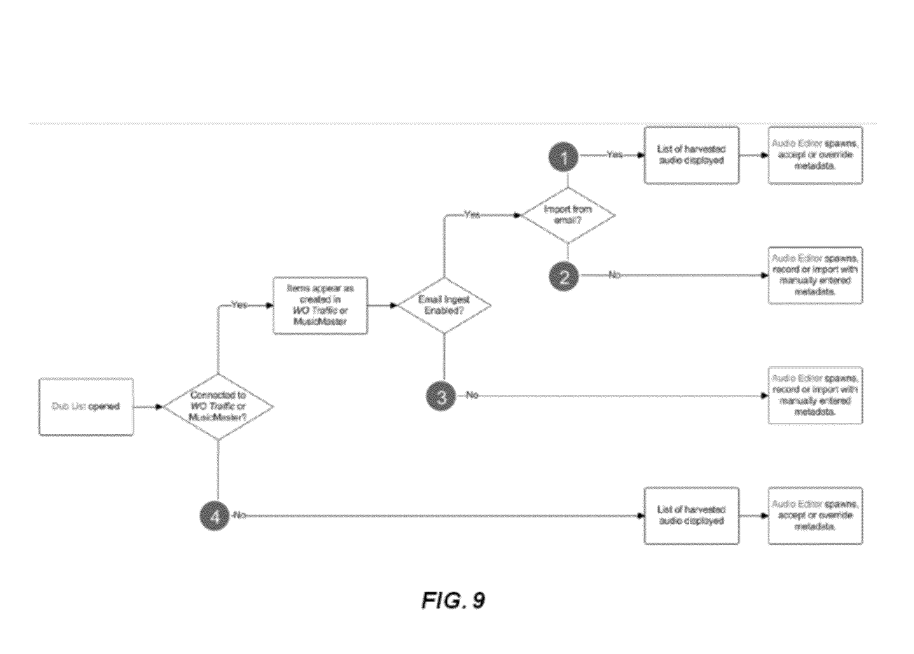

FIG. 9 shows an example of a method for using ingested audio files with the aid of a dub list widget. The method of FIG. 9 is facilitated using a broadcast content automation system that can be configured to ingest audio files, such as the system 700 of FIG. 7. With the dub list widget opened, the system determines whether the system is connected to a content scheduler, such as a music scheduler or an audio sales, traffic and billing system (“traffic system”), such as, for example, WideOrbit Traffic. If the system is not connected to a traffic system (“No”), then at point 4 the system presents a list of audio files harvested from email to a user on a GUI of the system. The audio files in such a case can be media assets if they are ready for use with commercial spots. The system then spawns an audio editor program (or module) to enable a user to accept or override metadata associated with the media assets in the list. Alternatively, if the system is connected to a traffic system, then at point 4 the system displays broadcast content to the user. The user can select broadcast content from the list and associate an audio file with the broadcast content. The system then determines whether an email ingest feature is enabled for the system, which feature allows the system to automatically ingest audio files and use the ingested audio files with broadcast content. If the email ingest feature is not enabled, then at point 3 the system permits the user to manually import or create audio files with the aid of the audio editor. However, if the email ingest feature is enabled, then the system determines whether any audio files have been automatically harvested (or ingested) from emails. If no audio files have been harvested (i.e., “No”), then at point 2 the system enables the user to manually import or create audio files with the aid of the audio editor. If audio files have been harvested (i.e., “Yes”), then at point 1 the system displays a list of harvested audio files to a user. The user can use the audio editor to accept or override metadata, and subsequently imported a harvested audio for use with broadcast content.

The audio editor can be used to verify metadata associated with ingested audio files, or to add or update metadata. An audio file that has been ingested can include metadata that has been automatically provided by the system or inputted by the user. Once an audio file has been ingested and metadata for the audio file has been generated, automatically by the system and/or manually by the user, the audio file is a media asset ready for use with broadcast content, such as commercial spots.

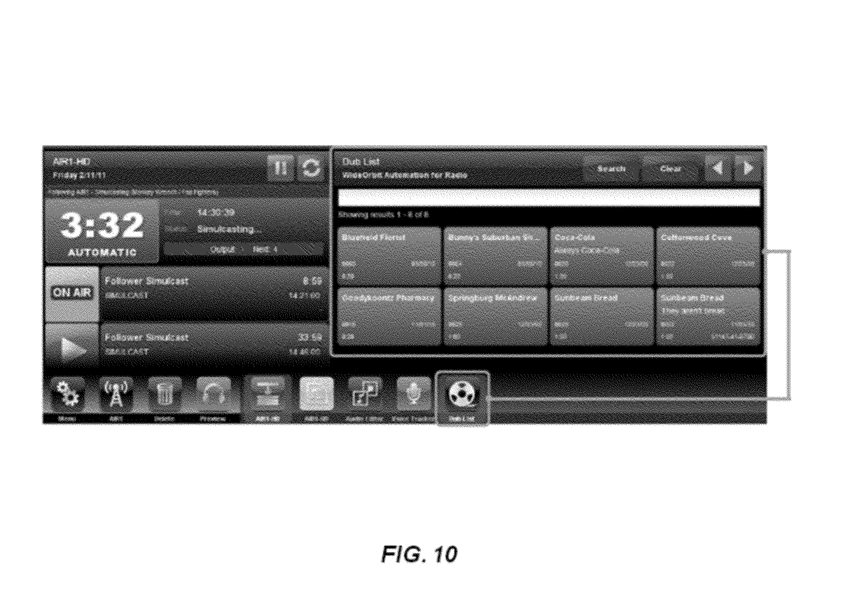

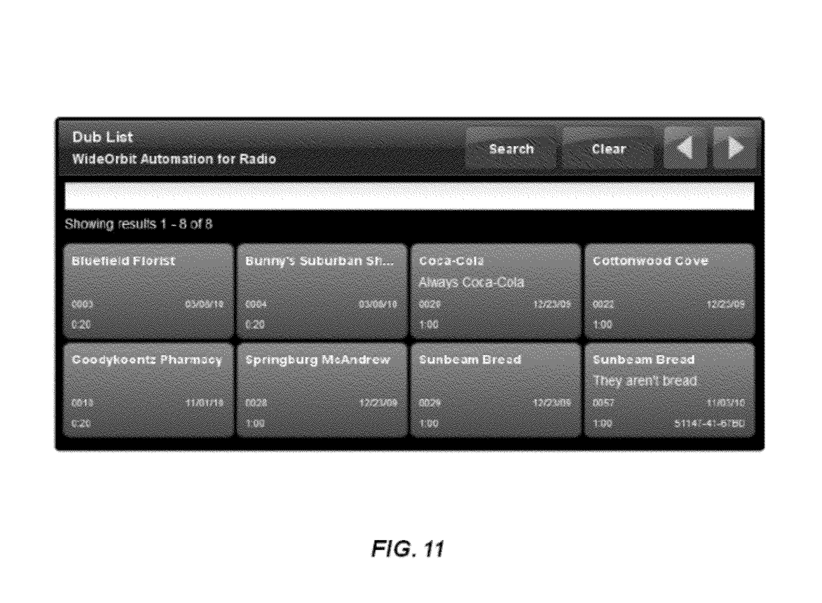

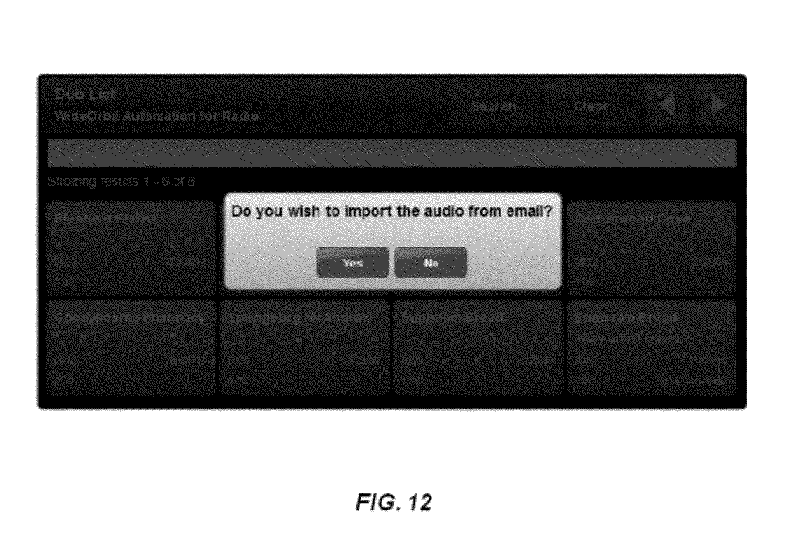

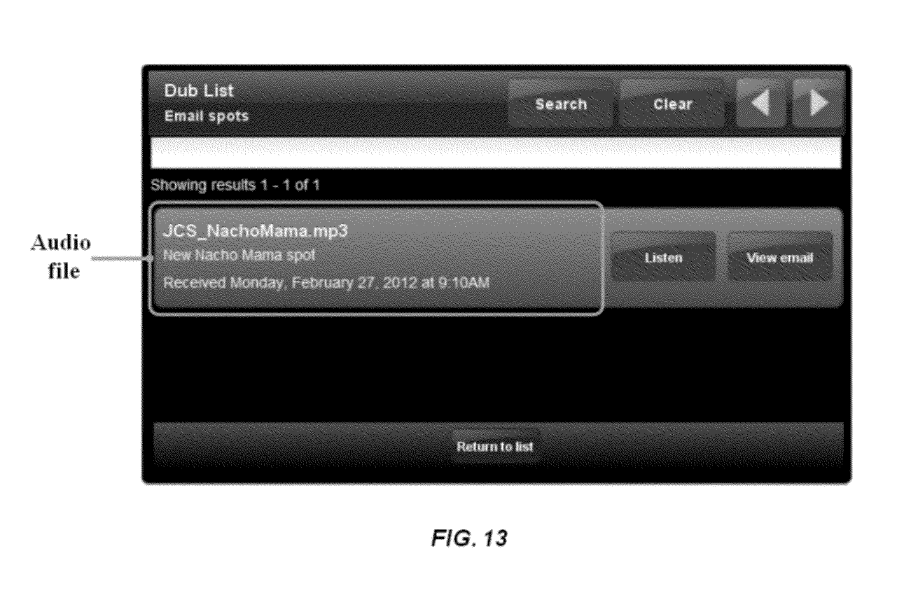

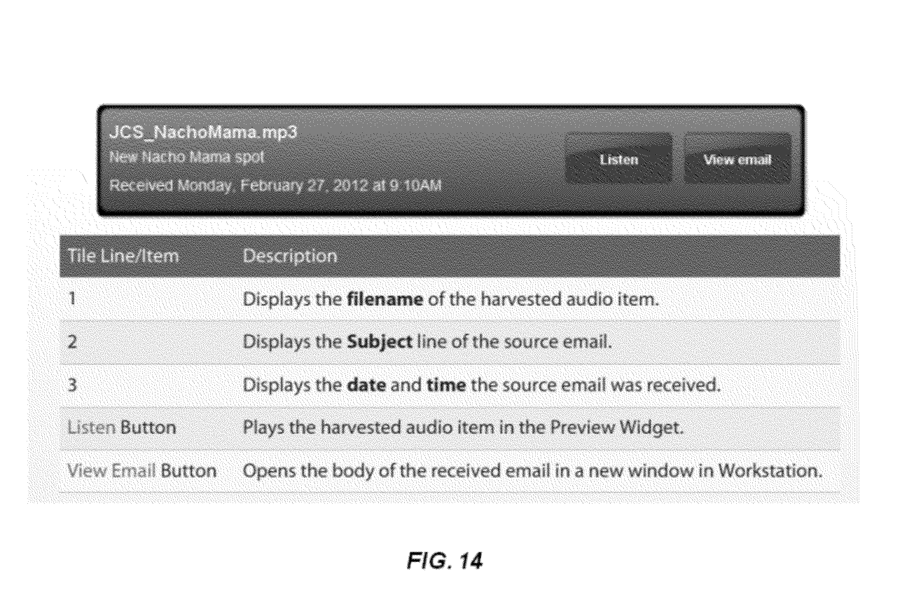

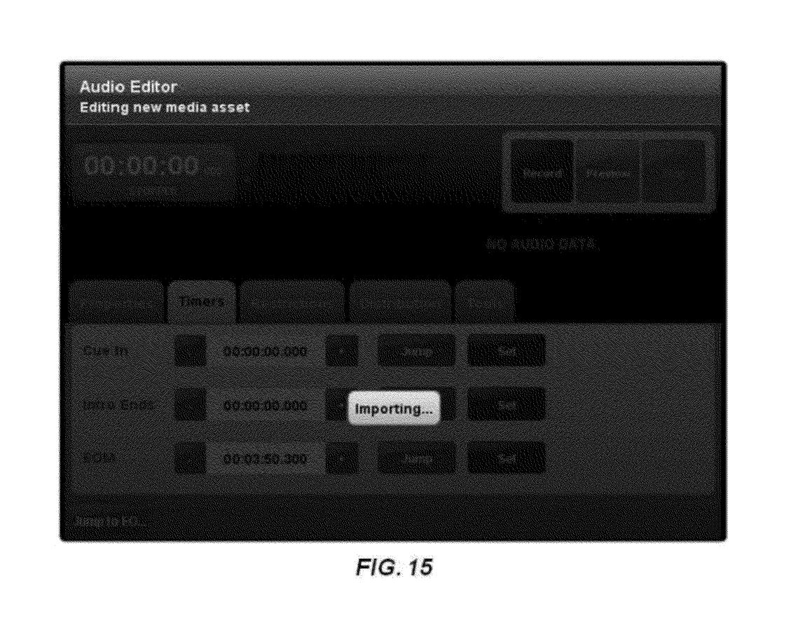

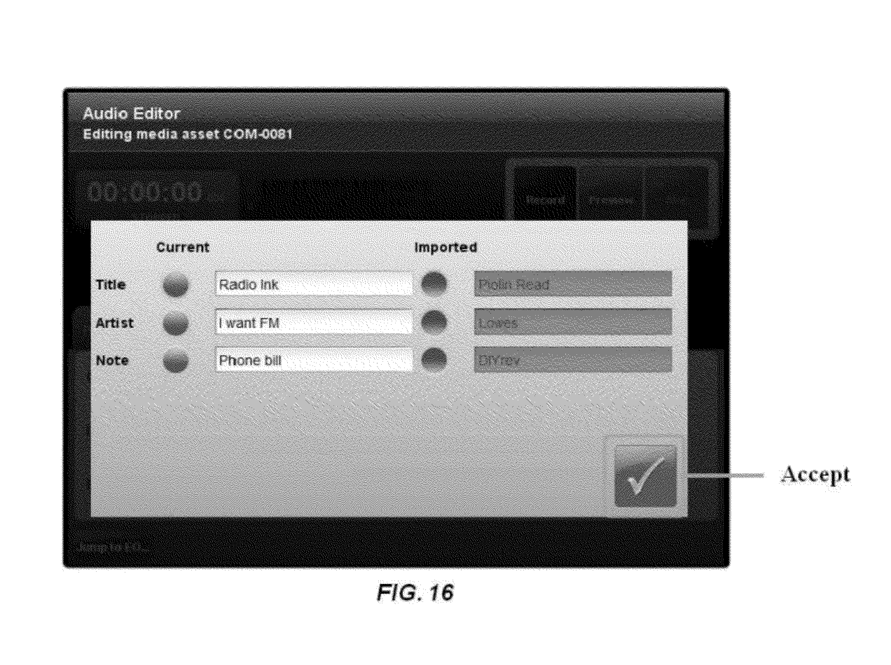

FIGS. 10-16 are screenshots associated with the workflow of FIG. 9. Using the broadcast content automation system, the user selects a dub list widget (FIG. 10) to display a dub list of broadcast content (FIG. 11). If email ingest is enabled, the user clicks on an item in the dub list and the system asks the user if the selected item should be used with an audio file (media asset) harvested email (FIG. 12). If the user elects to use a harvested audio file, the system will present a list of media assets to the user (FIG. 13). The list shown in FIG. 13 includes a single media asset (MP3 audio file) that has been harvested from email, and that can be used with the broadcast item selected from the dub list. With reference to FIG. 14, the list of media assets shows media assets and information relating to the media assets, such as the harvested name of the audio file. With reference to FIG. 15, the user elects to use the audio file of FIG. 14 with the broadcast content selected from the list of FIG. 11, and the system begin “Importing” the audio file for use with the selected broadcast content. With reference to FIG. 16, if the imported audio file includes metadata, the system displays the properties stored in the file in an “Imported” column, while metadata from a broadcast content scheduler are listed in “Current” column. The user can select a radio button to the left of each item of metadata to select the metadata that will be stored when the file is saved. When the user has selected the metadata to include with the imported audio file, the user can accept the information by selecting the accept button (check graphic).

Once a media asset has been imported, the system determines whether the media asset is within 3 seconds of the duration required by the system for use with the selected broadcast content. If there is greater variance, the system can display a warning to the user.

Once a harvested audio file has been imported, the system notifies the content scheduler that the item has been committed as a media asset and the item is removed from the Dub List. In some implementations, the system changes a status of the item to “Confirmed” and the item is removed from the dub list.

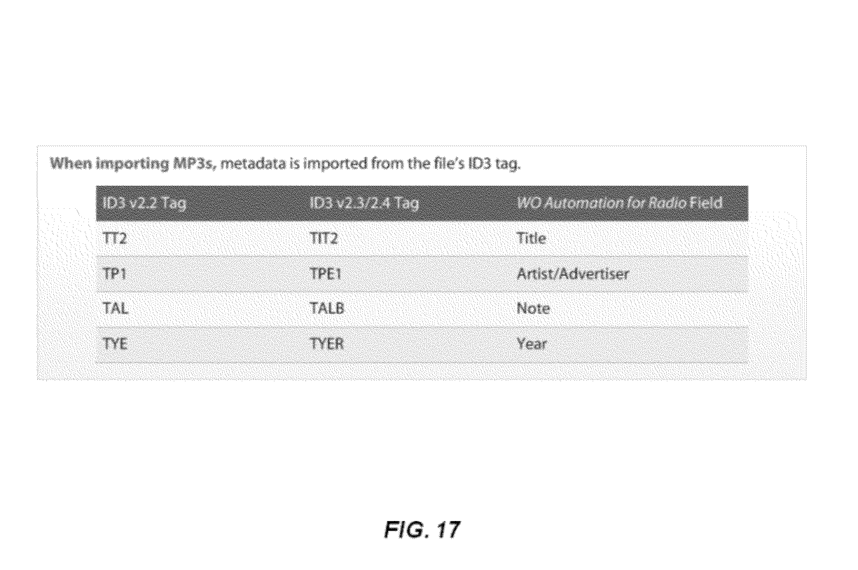

In some cases, upon importing an audio file from a list of media assess harvested from email, the system provides metadata that was included in the original audio file. For instance, if a harvested audio file includes an ID3 tag, as may be found in MP3 files, the system can provide metadata presented in FIG. 17 upon importing the harvested audio file.

Systems and methods provided herein may be combined with or modified with other systems and methods, such as, for example, systems and/or methods described in WO/01/35231 to Lundberg, WO/03/005276 to Kirani et al., and U.S. Patent Pub. No. 2008/0147746 to Bauchot et al., which are entirely incorporated herein by reference.

It should be understood from the foregoing that, while particular implementations have been illustrated and described, various modifications may be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method for retrieving a media file from an electronic mail for use with broadcast content, comprising:
(a) searching, with the aid of a processor, an electronic mail (email) account for an email having a media file embedded in or provided as an attachment to the email;
(b) identifying from said search an email having a media file embedded in or provided as an attachment to the email;
(c) importing the media file from said email into an electronic storage unit; and
(d) processing, with the aid of a processor, the media file for use in said broadcast content.

2. The method of claim 1, wherein importing the media file comprises harvesting the media file from the email.

3. The method of claim 1, wherein processing the media file comprises converting a format of the media file to another format.

4. The method of claim 1, wherein said media file is an audio file.

5. The method of claim 4, wherein step (d) comprises modifying a header of the audio file.

6. The method of claim 4, wherein step (d) comprises replacing a first header of the audio file with a second header.

7. The method of claim 4, wherein step (d) comprises converting the audio file from MP3 or WAV format to a proprietary format recognizable by a system that imports the media file from said email into said data repository.

8. The method of claim 7, wherein said proprietary format includes a proprietary header.

9. The method of claim 1, further comprising generating an electronic object having a link to the email and the processed media file.

10. The method of claim 9, further comprising:
generating metadata from the email and the media file, said metadata related to the email and the media file; and
associating said metadata with said processed media file.

11. The method of claim 10, wherein the metadata includes one or more of a file name of the media file, a length of the media file, a compression type of the media file, a timestamp in which the media file was imported, a timestamp in which the email having the media file was received, a subject of the email, a body of the email, a sender of the email, a recipient of the email, a location where the email is stored, a location where the media file is stored, and a location where a converted media file is stored.

12. The method of claim 1, wherein step (a) comprises accessing an email server.

13. The method of claim 12, further comprising accessing an account associated with a user.

14. The method of claim 1, further comprising processing the media file while importing the media file.

15. The method of claim 1, further comprising processing the media file after importing the media file.

16. The method of claim 1, wherein said media file is processed for use with a commercial.

17. The method of claim 1, further comprising:
committing said media file for use in said broadcast content; and
removing said media file from a list of imported media files.

18. A method for retrieving media files from electronic mail (email) for use with broadcast content, comprising:
(a) performing, with the aid of a processor, a search of one or more email accounts for email having media files for use with said broadcast content;
(b) importing from said one or more email accounts a media file, wherein said media file is attached to or embedded in an email revealed in said search, and wherein said media file is imported into a dedicated electronic storage unit on a server;
(c) forming, with the aid of a processor, a media asset from said media file, said media asset ready for use with broadcast content, wherein said media asset includes metadata associated with said media file; and
(d) generating, with the aid of a processor, a list of media assets for display to a user with the aid of a graphical user interface on a system communicatively coupled to said server, said list of media assets having said media asset.

19. The method of claim 18, wherein said server conducts said search.

20. The method of claim 18, wherein said broadcast content is a commercial.

21. The method of claim 20, wherein said commercial is a radio commercial.

22. The method of claim 18, further comprising:
committing said media asset for use with said broadcast content; and
removing said media asset from said list.

23. The method of claim 18, further comprising converting a format of said media file for use with said broadcast content.

24. The method of claim 18, wherein, after step (d), receiving a request from said user to use said media asset with said broadcast content.

25. The method of claim 24, further comprising generating metadata associated with said broadcast content and said media asset selected for use with said broadcast content.

26. A method for automatically ingesting media file attachments for use with broadcast content, comprising:
(a) scanning email in one or more email accounts for media file attachments corresponding to said broadcast content;
(b) importing media file attachments from said one or more email accounts into a data repository on a server;
(c) generating a list of media assets for display on a graphical user interface (GUI), each media asset on said list associated with a media file among said media file attachments; and
(d) committing a media asset from said list for use with said broadcast content.

27. The method of claim 26, wherein said committing comprises forming metadata associated with (i) said broadcast content and (ii) said committed media asset.

28. The method of claim 26, further comprising receiving a request for an automated broadcast content scheduler among a plurality of broadcast content schedulers.

29. The method of claim 28, wherein said automated broadcast content scheduler is an automated radio traffic management system.

30. The method of claim 28, wherein said automated broadcast content scheduler is an automated music scheduler.

31. The method of claim 26, further comprising combining metadata associated with said broadcast content with metadata associated with said committed media asset.

32. A method of ingesting media file attachments for commercial spot(s) automatically from electronic mail (email), comprising the steps of:
(a) scanning email from one or more email accounts for media file attachments corresponding to commercial spot(s);
(b) importing the media file attachments for commercial spot(s) from the one or more email accounts into an electronic storage location located on a server;
(c) providing a graphical user interface displaying a list having said media file attachments imported from said one or more emails accounts; and
(d) committing a selected media file from said list for use with a selected commercial spot.

33. The method of claim 32, wherein said committing comprises combining metadata corresponding to said selected media file with metadata corresponding to said selected commercial spot.

34. The method of claim 32, further comprising receiving a request for an automated broadcast content scheduler that schedules said selected commercial spot.

35. The method of claim 34, wherein said automated broadcast content scheduler is an automated radio traffic management system.

36. The method of claim 32, further comprising removing said selected media file from the list.

37. The method of claim 32, further comprising the step of:
converting the media file attachments for commercial spot(s) as required during or upon importing of the media file attachments.

38. The method of claim 32, further comprising generating metadata corresponding to said media file attachments.

39. A system, comprising:
(a) an electronic storage unit having machine-executable code that implements a method as in any of claims 1, 18, 26 and 32; and
(b) a computer processor for executing said machine-executable code.

40. An electronic data storage unit comprising machine-executable code that implements a method as in any of claims 1, 18, 26 and 32.
